(19) United States
(12) Patent Application Publication
(10) Pub. No.: US 2016/0332322 A1
(43) Pub. Date: Nov. 17, 2016

(54) Miter fold dado blade

(71) Applicant: Andrew J. Klein, Plymouth, MN (US)

(72) Inventor: Andrew J. Klein, Plymouth, MN (US)

(21) Appl. No.: 15/152,097

(22) Filed: May 11, 2016

Related U.S. Application Data
(60) Provisional application No. 62/160,086, filed on May 12, 2015.
(60) Provisional application No. 62/164,245, filed on May 20, 2015.
(60) Provisional application No. 62/188,205, filed on Jul. 2, 2015.

(51) Int. Cl. B27G 13/00; B27B 27/02; B23D 45/06; B27B 5/34

(52) U.S. Cl. CPC B27G 13/007; B27B 5/34; B27B 27/02; B23D 45/068

(57) ABSTRACT

A table saw cutting blade for cutting at least one joint. The cutting blade is adapted with a plurality of cutters of a shape which provides a cut profile allowing for smooth folding and formation of a substantially exact joint. The cut profile is configured to allow one side length of the cut profile to be folded upwardly along the cut line or joint to form a sidewall with respect to the opposing side of the cut line. One or more cuts made with the cutting blade can be folded along the cut length to easily and quickly produce a box or drawer from a single substrate.

### CROSS-REFERENCE TO RELATED APPLICATIONS

This application claims the benefit of U.S. Provisional Patent Application Ser. No. 62/160,086, filed on May 12, 2015 and U.S. Provisional Patent Application Ser. No. 62/164,245, filed on May 20, 2015 and U.S. Provisional Patent Application Ser. No. 62/188,205, filed on Jul. 2, 2015, the contents of which are all incorporated herein in their entireties.

### BACKGROUND

This disclosure relates to a table saw cutting blade. More specifically, the cutting blade is a blade for cutting a joint in a substrate for forming a box or drawer from a single piece of a substrate.

### SUMMARY

An aspect of the present disclosure relates to a cutting blade configured to cut a joint. The blade is a blade for use with a standard table saw and various dado stacks. The blade is adapted with a plurality of cutters of a shape which, when a piece of wood or similar material is cut with the blade, the blade produces a cut profile along a length of the wood. The cut profile produces a joint and the cut profile is configured to allow one side length of the cut profile to be folded upwardly along the cut line or joint to form a sidewall depending on the positioning of the cut with respect to the wood substrate. The cut or cuts made with the cutting blade, when the sides of the cut are folded upwardly towards one another to produce a substantially square edge. The cut profile is also configured for easy removal of excess wood, for example, corner sections not required for folding a substantially flat substrate into a box or drawer configuration. One or more cuts may be made in various orientations on a substrate to produce a drawer, box or similar container having one or more sides, or upturned edges.

Another aspect of the present disclosure relates to a miter fold dado cutting blade and dado stack comprising a miter fold dado cutting blade having a plurality of non-flat cutting surfaces to produce a portion of a cut profile in a workpiece and at least one dado cutting blade having a plurality of flat cutting surfaces to produce a substantially symmetric portion of a cut profile in the workpiece. The miter fold dado cutting blade and the at least one dado cutting blade together form a non-symmetric cut profile for forming a bend line in the work piece. The plurality of non-flat cutting surfaces have a shape with an offset apex protruding from the blade body and the miter fold dado cutting blade and dado stack may also comprise a spacing unit for forming a bend line in the substrate such that opposing sides of the bend line can be folded about 90 degrees to form an edge.

Yet another aspect of the present disclosure relates to a method of producing one or more bend lines in a substrate for faulting a drawer or box comprising providing a piece of wood for forming the drawer and providing a blade assembly comprising a plurality of blades, wherein one blade is a joint cutting blade having a plurality of cutting blades extending therefrom and wherein the cutting blades of the joint cutting blade are different in shape than a second plurality of cutting blades of a second blade in the plurality of blades such that the blade assembly forms a selected, non-symmetrical cut profile in a substrate to form the bend line such that the selected non-symmetrical profile is configured to produce a joint along the cut line; and forming at least one bend line on a surface of the piece of wood along at least one side length to form at least one sidewall portion with respect to a base portion of the drawer along at least one bend line. The piece can be rotated about 180 degrees and additional bend lines formed for forming additional sides of the drawer or box and a rip fence of a table saw may also require repositioning between forming additional bend lines in the substrate.

### BRIEF DESCRIPTION OF THE DRAWINGS

FIG. 1 is a perspective view of a miter fold dado blade of the present disclosure.

FIG. 2 illustrates the cut profile associated with the miter fold dado blade for forming joints.

FIG. 3 is a representation of a cut profile associated with the dado blade and a dado stack for forming joints.

FIG. 4 illustrates the method of forming a joint from a workpiece having the cut profile made therein.

FIG. 5 is a flow diagram illustrating the forming of the joints for assembling a box or drawer along one or more joints formed by the miter fold dado blade and dado stack.

FIG. 6 is a flow diagram illustrating a second method for forming the joints for assembling a box or drawer along one or more joints formed by the miter fold dado blade and dado stack.

FIG. 7 illustrates an embodiment wherein the miter fold dado blade comprises two pieces separated by a spacer.

FIG. 8 is a perspective view of the miter fold dado blade and dado stack including a spacer.

FIG. 9 is a side view of the miter fold dado blade and dado stack including a spacer.

### DETAILED DESCRIPTION

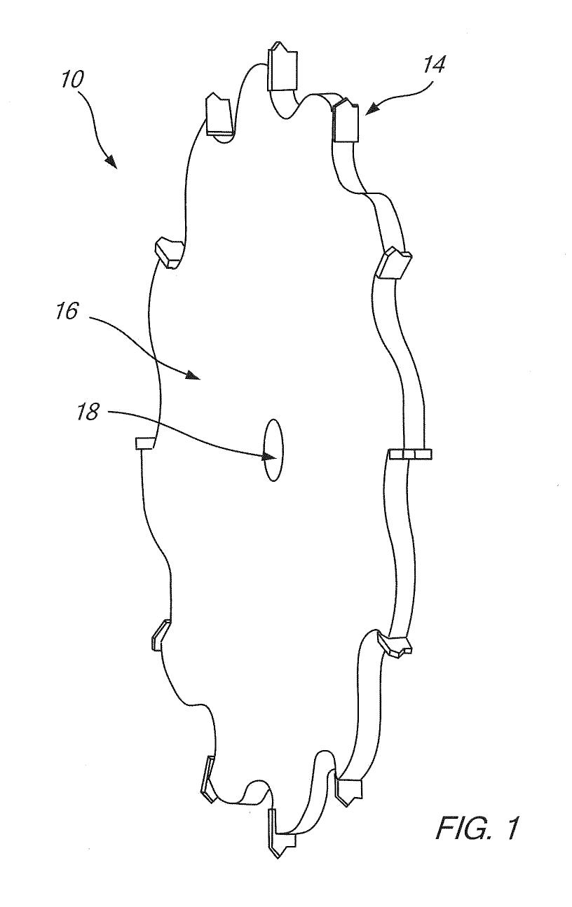

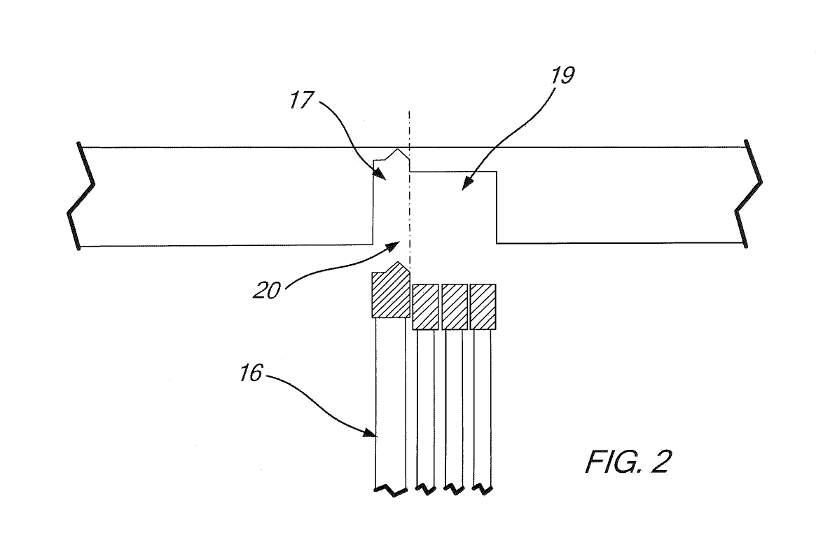

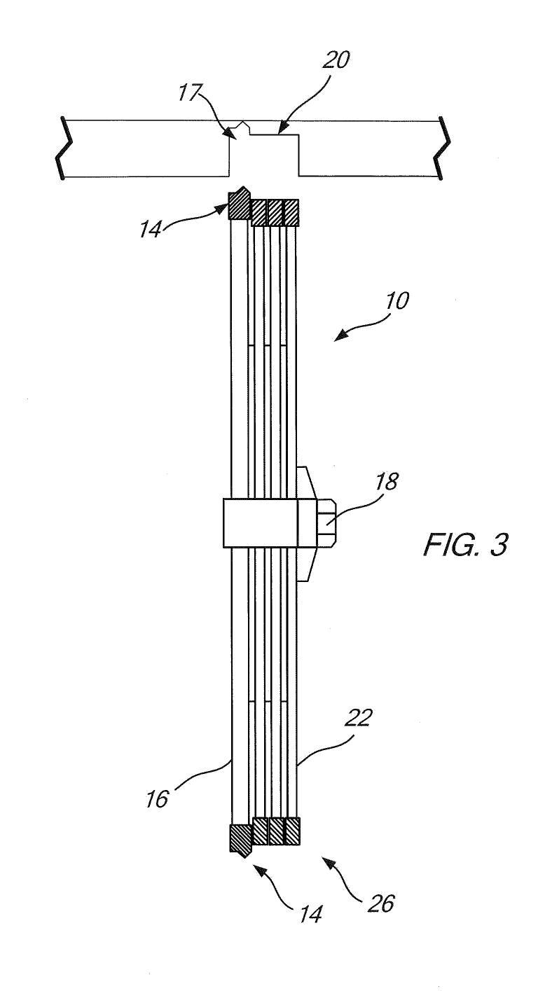

A miter fold dado blade 10 for forming a joint in a workpiece according to the present disclosure is illustrated generally at FIG. 1. The blade 10 comprises a plurality of carbide cutters 14, and in the embodiment illustrated, the blade comprises twelve (12) carbide cutters 14 affixed to a blade body 16. The body of the blade is comprised of steel. The body is further adapted with an arbor 18 meant to accommodate standard table saw shaft size. For example, the arbor is a ⅝″ arbor. The miter fold dado blade, also referred to as a “joint cutting blade” 10 can also be incorporated into a dado stack 22 to produce a custom stack and cut profile as illustrated in FIGS. 2-3. Spacers 24 are also used for customizing the dado stack 22 and cutting blade 10 arrangement.

The carbide cutters 14 have a custom shape that is distinct from the cutter of a standard dado blade. The shape of each cutter 14 comprises an angled upward protrusion 15 which is configured to provide a cut profile 17 allowing the cut to act as a joint. The joint cutting blade 10 is further configured for use with a standard dado stack to cut one or more joints in a substrate or workpiece. The substrate or workpiece may be, but is not limited to, a plywood sheet. The joint cutting blade 10 comprises a non-symmetric shape in order to cut the opposing sides of the joints in a single pass. The shape of the cutter 14 allows the plies to come together cleanly at approximately a 90 degree angle with little to no gap in the joint and sufficient room for a thin layer of adhesive used to glue the joint in an assembled (folded) position.

The joint cutting blade 10 of the present disclosure is configured to allow for easy assembly of a drawer or box (or other geometric shape having edge portions). Cuts made with the cutting blade 10 eliminate the need for assembling a box or similar object from a plurality of cut pieces. There is no need to match and secure individual pieces together for forming the box or drawer.

Relief cuts on the blade preceding each carbide cutter are sufficient to allow for discharge of wood shavings. Each carbide cutter 14 is affixed to the steel body 16 with a brazing weld consistent with the standard fabrication of carbide tooth table saw blades. Each carbide cutter 14 has a top clearance angle, tangential clearance angle, radial clearance angle, and hook angle sufficient to provide clean, un-burnt, cuts in solid wood and plywood. Right hand clearance distance between the blade body 16 and the carbide cutters 14 is fabricated so that a standard spacer can be used in conjunction with a dado stack 22 for a precise combination of dado and joint cutter blade profiles. Left hand clearance is sufficient to provide clearance between the blade body and the wood product being cut. The cut profile of the cutting blade is illustrated in FIG. 2, while the cut profile of the dado stack and cutting blade is illustrated in FIG. 3.

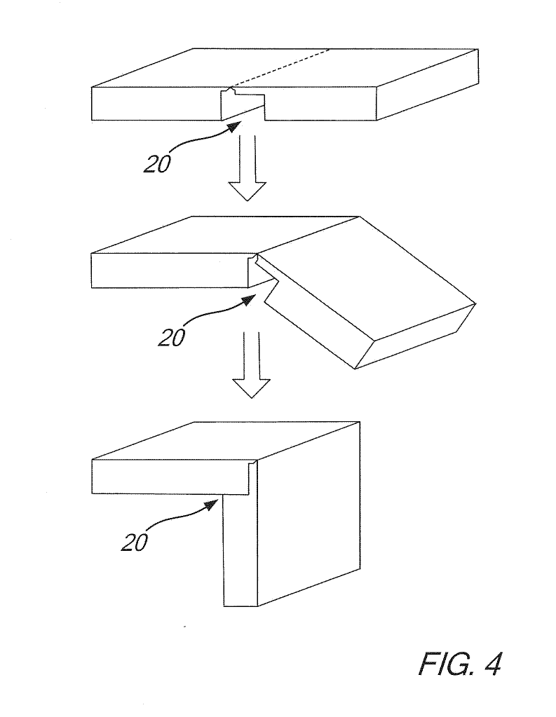

Illustrated in FIGS. 2-3 is a side view of a cut profile 20 that the joint cutting blade 10 and dado blade (or stack) 22 can make in a piece of solid wood or plywood. Note that this may not be the dimensions of the cutter itself, as the cutters 14 may be affixed to the blade body 16 at an angle to provide a joint capable of providing a clean 90 degree angle between a base and side wall of an assembled box. The angle may be a forward or backward angle with respect to the blade body 16 as the cutters protrude upwardly from the blade body 16. The embodiment illustrated specifies an outside blade diameter of 8 15/32″, which is appropriate for use with a dado set with an outside diameter of 8 3/32″. Different diameter dado blades generally would require joint cutting blades with diameters ⅜″ larger than their own diameter. Exact dimensions can be altered without compromising the function of the cutting blade 10 so long as the two mating profiles 17 and 19 cut into the wood to provide a cut profile 20 where the mating profile 17 and 19 meet substantially exactly when one side is rotated 90 degrees around the outer tip of the cut as illustrated in FIG. 3-4. The mating profiles may be represented by Equation 1, where profile 19 results from a dado stack configured for cutting a profile having width W_{D} and where the height (or depth) of cut profile 17 is represented as H_{C}, thus:

W_{D}=H_{C}−((H)sinθ) (Equation 1)

where h is the length of a diagonal segment to the point of profile 17 and θ is the angle between the base and the diagonal length.

The cutting blade 10 and cut profile 17 allow a substantially exact joint to be formed in a continuous substrate, without separating the substrate into a plurality of individual pieces for assembly. The dado blade 22 and joint cutting blade 10 together cut a profile 20 into the substrate, where the joint cutting blade 10 provides a cut profile 17 relating to the joint angle (approximately 90 degrees) and the dado blade 22 provides a cut profile 19 corresponding to the thickness of the substrate so that together, the cut profile 20 provide a joint line for folding or otherwise assembling a box having four side walls that cleanly fit together for easy assembly from a single piece of material.

FIG. 4 illustrates the forming of a side by folding the substrate along the length of the cut such that the cut profile 17 forms the 90 degree bend and clean apex of the joint and cut profile 19 allows the opposing sides to cleanly match for a supported and secure joint. The potential to make the entire mating profile with a single blade without an accompanying dado stack is also within the scope of this disclosure.

A method of constructing a drawer using the joint cutting blade 10 of the present disclosure requires a plurality of cuts to be made in series into a single workpiece of plywood (or similar material). Each cut forms a “bend line”, which is a joint allowing the plywood to be folded or bent along the bend line. A cutting blade 10 and dado stack 22 together cut profile 20 into a piece of plywood. Constructing a drawer from a single piece of plywood first requires selecting a blade assembly 23 (102). The blade assembly 23 includes a joint cutting blade and a dado stack as well as optional spacers for use with different diameter dado stacks. The blade assembly 23 is selected such that a dado stack 22 of selected diameter and a cutting blade 10 having a corresponding diameter (i.e. approximately ⅜″ larger) are mounted for use onto a table saw. A new zero clearance insert may be required and initially cut. Setting the blade assembly 23 height includes setting the joint cutting blade 10 to a height such that the apex of a cutter 14 is just below the upper edge of the plywood (104). This allows the blade assembly 23 to cut the profile into the plywood without cutting completely through and separating the plywood. The cut made by the dado stack 22 will be shallower than the cut made by the joint cutting blade 10 such that opposing sides of the cut line remain intact after passing over the joint cutting blade 10 and dado stack 22, thus forming the bend line.

Positioning the highest point of the cutting blade at a height relative to the thickness of the plywood allows the cutting blade to cut into the plywood a sufficient depth to form a bend line but does not cut the upper layer of the plywood, so the blade does not cut entirely through the plywood and the single piece plywood can be used to assemble a drawer (or a box). To make the drawer, the height, length and width of the plywood should be measured and based on those dimensions, the position of the cuts around the perimeter of the plywood can be selected such that the box will have a selected base size and side wall depth.

### EXAMPLE 1

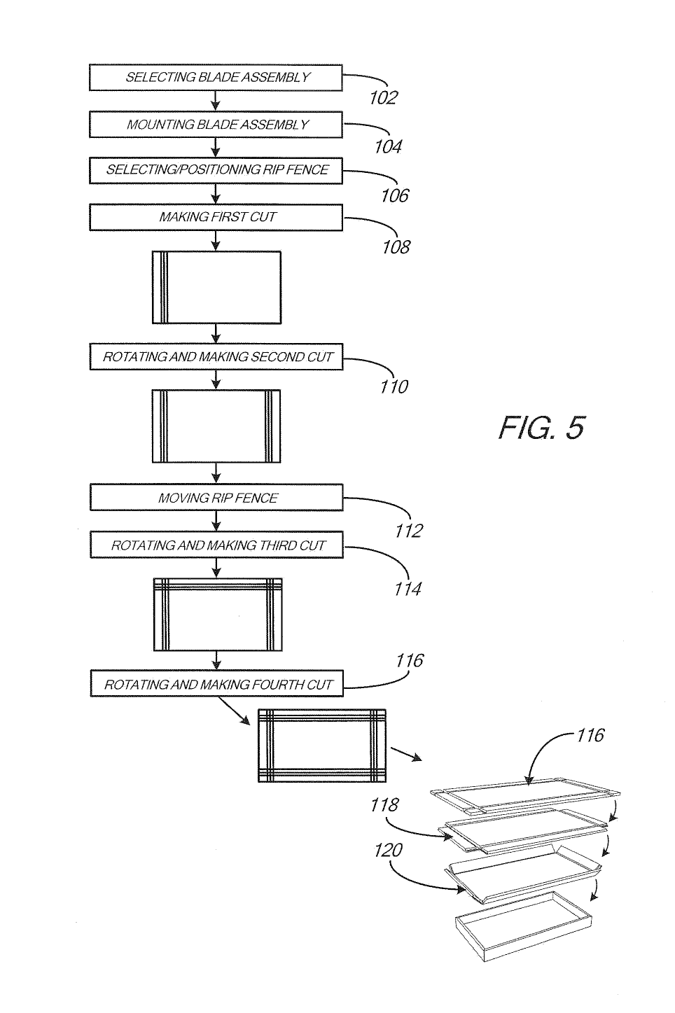

A drawer (or box) may be assembled by making a series of four cuts to produce four corresponding bend lines as illustrated in FIG. 5. Once the blade assembly has been selected and mounted as described previously above (102, 104), four individual cuts are made into the plywood to form a drawer. It may be beneficial to apply tape along the length of the cut on the opposite side of the plywood, as this tape will reinforce the surface opposite the bend line and will aid in assembly. A rip fence is first positioned (106) on a first side of the blade assembly 23 and a first cut is made along a first side of the plywood (108). The plywood is rotated 180 degrees and a second cut is made (110) along a second side of the plywood, where the second side is a side that opposes the first side. The rip fence is then moved to the opposite side of the blade assembly (112). The rip fence, on each side of the blade assembly, is secured a selected distance from the portion of the cutting blade that establishes a “bend” line on a plywood substrate. A distance from this bend line to a nearest edge of the plywood establishes the height of the box side wall. The plywood is rotated 90 degrees and a third cut is made (114). The third cut is adjacent to and perpendicular to both the first and the second cut lines. The plywood is again rotated 180 degrees and a fourth cut is made (116) along a fourth side of the plywood, wherein the fourth side is a side that opposes the third side. The portion of plywood or the space between the bend lines on each opposing side of the plywood defines the interior base or floor of the box when assembled.

A substantially square corner is formed at the intersection of each two perpendicular cuts, or bend lines. These corners can each be removed (118) by finishing the cut with a knife blade along the outer boundary of each bend line within this corner area bounded by the intersection of the perpendicular cuts. Removing these corners allows for the formed sidewalls to be folded upwardly to form a substantially 90 degree edge. Making the cut in this opposing manner allows the sides of the drawer to match at the corners when folded up for easy assembly with no gaps or open areas. Nails and adhesive or other securing means, including a combination of securing mechanisms may be used to secure the four sides walls upwardly at substantially 90 degree angles with respect to the interior floor of the drawer. For example, adhesive may be applied to the bend lines before bending each sidewall upwardly along the bend line (120) and optionally nails may be used at the base of the bend to further secure sidewalls upwardly with respect to the interior floor of the drawer.

### EXAMPLE 2

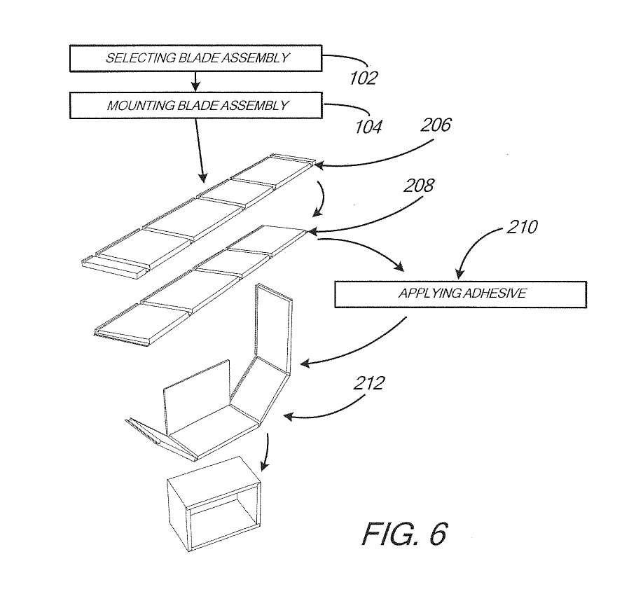

A drawer (or box) may also be assembled by making a series of five parallel cuts to produce three bend lines as illustrated in FIG. 6. Using this method, multiple boxes may also be constructed at the same time and separated by a cut from a saw blade. Two parallel grooves are first cut extending along a width of the plywood piece using a standard saw blade (204). These grooves will hold the base or bottom piece of plywood that will be inserted before assembly. Once the blade assembly has been selected and mounted as described previously above (102, 104), five individual cuts are made into the plywood to form a drawer and grooves for the base of the drawer or box are made. The five cuts are made in series and are parallel in the same direction (206). The cuts for the joint lines are spaced apart along the width of the plywood piece according to the selected dimensions of the drawer or box. The distance between the cuts dictates the width/depth size of the drawer. Tape may similarly be applied to back side of the three interior cuts prior to cutting (second, third, and fourth cuts), while the two opposing end cuts (first and fifth cuts) need not require tape as these opposing end cuts will mate together to close the box. The material on the outside of the bend lines made by the first and last cut is removed as waste (208) by cutting with a knife for removal. Glue or other adhesive is applied to each of the bend lines produced by the second, third and fourth cuts and glue is also applied to the seam which is formed by the first and the fifth cut (210). The drawer or box is then formed by wrapping up the sides so that the opposing ends mate to form the seam (212).

The cutting blade 10 described throughout this disclosure can be used to provide a joint cut profile 17 that together with a cut profile from a dado stack 19 provides a profile 20 that allows for the expedient construction of drawers and boxes by methods including, but not limited to making four cross profile cuts and folding the edges upwardly to produce a drawer or box and taking care that perpendicular cuts reverse the asymmetric cut profile, cutting out the corners, and folding up and gluing the sides; or by cutting five parameter cuts in a single sheet of plywood, and wrapping the sides around a base section inserted into a groove to produce the drawer or box.

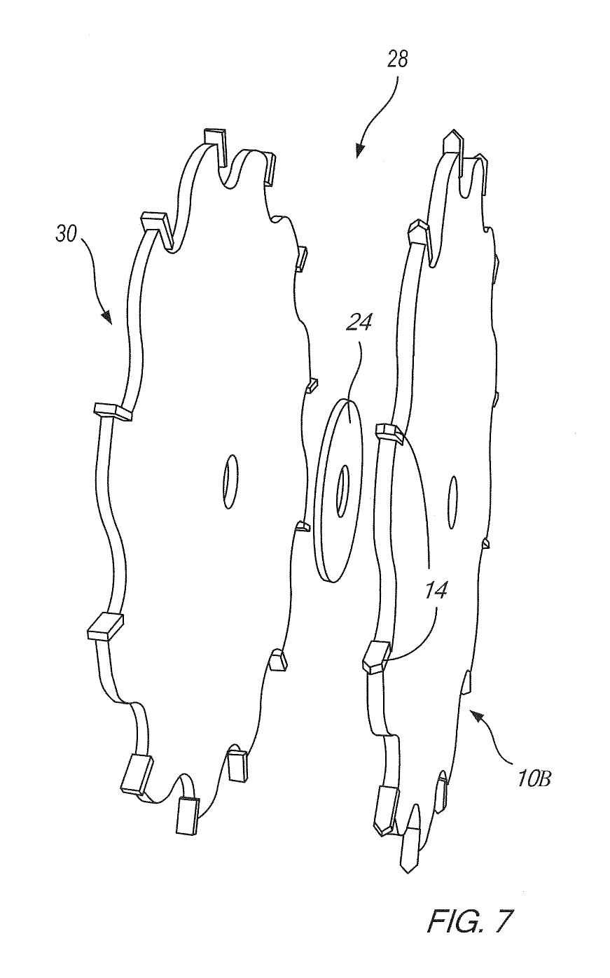

A miter fold dado blade assembly 28 is illustrated in FIG. 7. The cut profile 20 may be made with one or more blades. In the embodiment illustrated, the portion of the cut profile 17 (referring back to FIG. 2) is produced or formed using two or more blades (in contrast to a single blade 10) where the two blades are separated by a spacer 24. The additional portion of the overall the cut profile, cut profile 19 (referring back to FIG. 2) is produced or formed with 1 or more dado blades. At least one of the blades in the assembly 28 is a joint cutting blade 10B configured with angled ends provided by cutters 14. The joint cutting blade 10B is one of the two or more blades used to produce cut profile 17 along with a second blade 30 and spacer 24. In the embodiment illustrated, the angled ends of cutters 14 of blade 10B are approximately a 90 degree apex. The additional cutting blade(s) 30 is/are the second blade that comprises the two part joint cutting blade assembly 28. When combined, joint cutting blade 10B and second blade 30 together accomplish a function substantially similar to blade 10 referring back to FIG. 1. The diameter of second blade 30 is generally larger than a dado blade while also generally smaller than an outer tip of blade 10B. Additional blades 30 have cutters that are substantially flat. The joint cutting blade 10B and additional cutting blade(s) 30 are separated by the spacing unit 24, which comprises a spacer 24 or a plurality of spacers having a selected thickness and providing a selected space between the two blades in the assembly 28 which comprises the joint or miter fold dado blade 10B and the second blade 30. The additional cutting blades 30 may have a dimension which produces a cut profile 17 (with blade 10B and spacer 24) such that along with blades used to form cut profile 19 together form cut profile 20 allowing for clean folding and mating of the opposing sides of the bend line formed by the blade assembly.

The spacer 24 provides an advantage in achieving the cutting profile by allowing a user to increase or decrease the thickness of the spacer so that the cut profile can be slightly adjusted to compensate for slightly larger or smaller diameter dado blades. Thus, one set of blades can be provided with multiple different thickness spacers such that the blade can be used with different table saw systems or can be compatible with various different dado stacks from different manufacturers. The spacers can be combined or a single spacer of selected thickness will work with a respective sized dado stack to provide gap free joints along the bend lines by the cutting methods described herein. It is also contemplated that each spacer can correspond in thickness and size bearing a label to identify which exact dado blade diameters the spacers correspond to for achieving the cut profile described herein, allowing for easy selection and use by the customer to form a drawer or box.

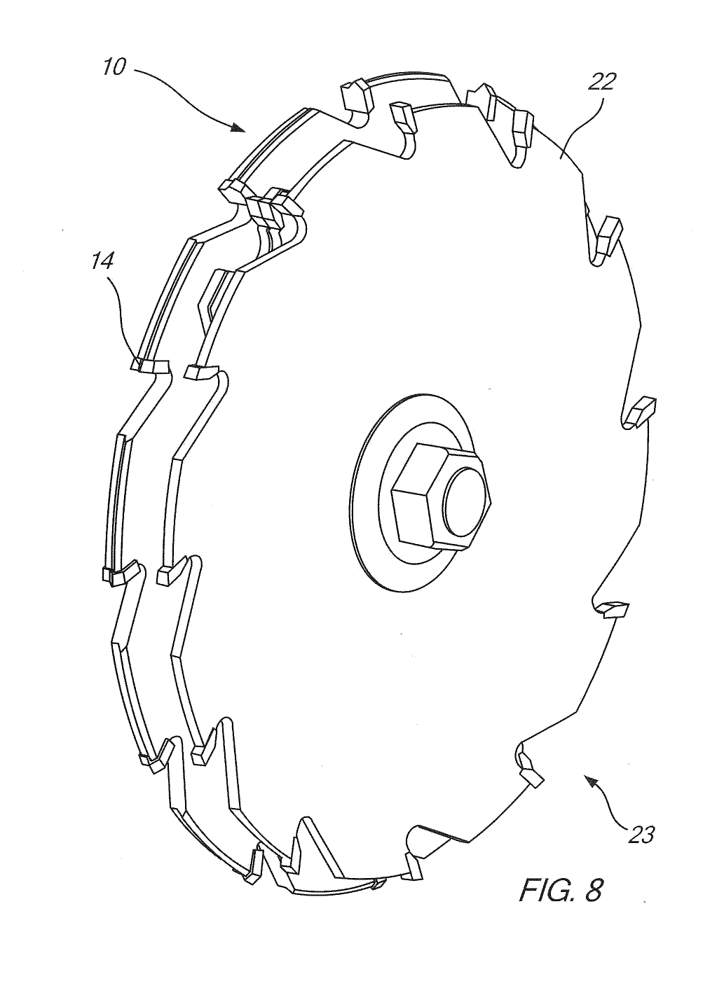

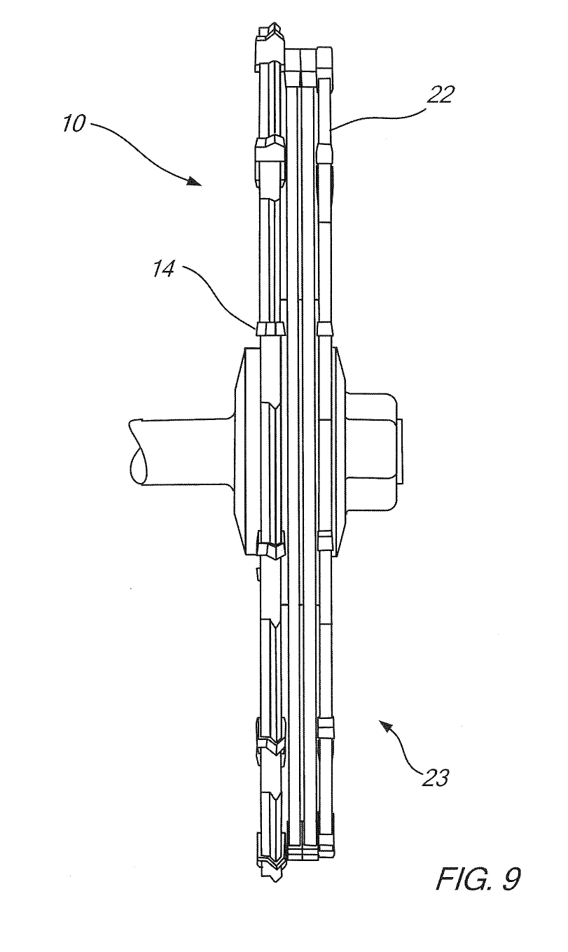

As illustrated in FIGS. 8 and 9, the miter fold dado blade 10 can be used with additional, standard cutting blades or dado blades to form a cut profile 20 proportional to the thickness of the workpiece to form an edge that is substantially flush or sealed (no gaps or open spaces along the bend line when bend/folded for assembly).

Although the present disclosure has been described with reference to preferred embodiments, workers skilled in the art will recognize that changes may be made in form and detail without departing from the spirit and scope of the disclosure.

1. A miter fold dado cutting blade comprising:
a blade body having a plurality of cutting blades extending therefrom, the cutting blades having a shape configured to produce a bend line in a substrate and producing a cut profile configured to provide a joint in the substrate for forming an edge in the substrate and wherein the cutting blades may be positioned at a forward or backward angle along the blade body.

2. The joint cutting blade of claim 1, wherein the plurality of cutting blades provide a non-symmetrical cut profile in the substrate.

3. The joint cutting blade of claim 2, wherein the plurality of cutting blades are of a shape having an offset apex.

4. The joint cutting blade of claim 1, and further configured for use with a dado stack comprising one or more flat cutting blades in addition to the joint cutting blade.

5. The joint cutting blade of claim 4, and further comprising a spacing unit to cut a joint profile such that substrate on the opposing sides of the joint can be folded 90 degrees to form the edge.

6. The joint cutting blade of claim 5, wherein the spacing unit is positionable between the joint cutting blade and the dado stack and having a variable thickness such that the spacing between the blade and the dado stack can be adjusted to a selected distance to account for different diameter dado stacks.

7. A miter fold dado cutting blade and dado stack comprising:
a miter fold dado cutting blade having a plurality of non-flat cutting surfaces to produce a portion of a cut profile in a workpiece; and
at least one dado cutting blade having a plurality of flat cutting surfaces to produce a substantially symmetric portion of a cut profile in the workpiece.

8. The miter fold dado cutting blade and dado stack of claim 7, wherein the miter fold dado blade and the at least one dado cutting blade together form a non-symmetric cut profile for forming a bend line in the work piece.

9. The miter fold dado cutting blade and dado stack of claim 7, wherein the plurality of non-flat cutting surfaces have a shape with an offset apex protruding from the blade body.

10. The miter fold dado cutting blade and dado stack of claim 7, and further comprising a second dado cutting blade and a spacing unit positioned between the miter fold dado cutting blade and the dado cutting blade for forming a non-symmetric cut profile in a workpiece and thus forming a bend line in the substrate such that opposing sides of the bend line can be folded about 90 degrees to form an edge.

11. A method of producing one or more bend lines in a substrate for forming a drawer or box, the method comprising:
providing a piece of wood for forming the drawer;
providing a blade assembly comprising a plurality of blades, wherein one blade is a joint cutting blade having a plurality of cutting blades extending therefrom and wherein the cutting blades of the joint cutting blade are different in shape than a second plurality of cutting blades of a second blade in the plurality of blades such that the blade assembly forms a selected, non-symmetrical cut profile in a substrate to faun the bend line such that the selected non-symmetrical profile is configured to produce a joint along the cut line; and
forming at least one bend line on a surface of the piece of wood along at least one side length to form at least one sidewall portion with respect to a base portion of the drawer along at least one bend line.

12. The method of claim 11, and further comprising:
rotating the substrate approximately 180 degrees and forming a second, parallel bend line on the piece of wood along a second side length opposing the first side length to form at second sidewall portion with respect to a base portion of the drawer along at least one cut line;
rotating the piece of wood approximately 90 degrees and forming a third bend line perpendicular to the first and second bend lines on the piece of wood along a third side length to form a third sidewall portion with respect to a base portion of the drawer along at least one bend line; and
rotating the piece of wood approximately 180 degrees and forming a fourth bend line parallel to the third bend line on the piece of wood along a fourth side length to form at fourth sidewall portion with respect to a base portion of the drawer along at least one bend line.

13. The method of claim 12, and further comprising
applying adhesive in each of the four bend lines; and
folding each of the sidewall portions along the at least one bend line to form four opposing upturned edges, each having approximately a 90 degree angle with respect to the base portion and securing the sidewalls upwardly at a substantially 90 degree angle to form a drawer.

14. The method of claim 12 wherein the method further comprises repositioning a rip fence to an opposing side of the blade assembly for forming additional bend lines.

15. The method of claim 11, wherein the plurality of cutting blades of the joint cutting blade are of a shape having an off-center apex.

16. The method of claim 11, and further comprising a spacing unit to cut a joint profile such that substrate on the opposing sides of the joint can be folded 90 degrees to form the edge.
